(19) United States
(12) Patent Application Publication
(10) Pub. No.: US 2026/0205193 A1
(43) Pub. Date: Jul. 16, 2026

(54) OPTICAL WIRELESS COMMUNICATION TERMINAL AND COMMUNICATION LINK FAILURE RESOLUTION METHOD THEREOF

(71) Applicant: Electronics and Telecommunications Research Institute, Daejeon (KR)

(72) Inventors: Chan IL Yeo, Daejeon (KR); Si Woong Park, Daejeon (KR); Young Soon Heo, Daejeon (KR); Keo Sik Kim, Daejeon (KR); Hyoungjun Park, Daejeon (KR); Kyeeun Kim, Daejeon (KR); Daegil Kim, Daejeon (KR); Kwang Su Yun, Daejeon (KR); Sim-Kwon Yoon, Daejeon (KR)

(21) Appl. No.: 19/450,666

(22) Filed: Jan. 15, 2026

(30) Foreign Application Priority Data
Jan. 15, 2025 (KR) 10-2025-0006109
Aug. 26, 2025 (KR) 10-2025-0119438

(51) Int. Cl. H04B 10/03; H04B 10/079; H04B 10/40

(52) U.S. Cl. CPC H04B 10/03; H04B 10/07955; H04B 10/40

(57) ABSTRACT

An optical wireless communication terminal includes an optical wireless transceiver and an integrated controller which monitors an output signal or operation information of the optical wireless transceiver. The integrated controller may monitor an abnormality in a communication link or a relay operation condition based on at least one criterion among a received signal strength and a change in a transmission directional angle, while the optical wireless transceiver transmits or receives optical wireless data to or from a first optical wireless communication terminal, when the abnormality in the communication link or the relay operation condition is detected, the integrated controller may perform a rebooting operation of the optical wireless transceiver, re-establish a communication link with the first optical wireless communication terminal after the rebooting operation, and retransmit or receive again, through the optical wireless transceiver, the optical wireless data whose transmission or reception has been interrupted.

### CROSS-REFERENCE TO RELATED APPLICATION

This application claims priority to and the benefit of Korean Patent Application No. 10-2025-0006109, filed on Jan. 15, 2025, and Korean Patent Application No. 10-2025-0119438, filed on Aug. 26, 2025, the disclosure of which are incorporated herein by reference in its entirety.

### BACKGROUND

### 1. Technical Field

The enclosed disclosure is related to free space optical wireless communication technology.

### 2. Related Art

Optical wireless communication technology is an ultra-high-speed and large-capacity communication technology that utilizes free space (e.g., the atmosphere or outer space) as a communication channel. The optical wireless communication technology economically, effectively, and flexibly supports the establishment of ultra high speed and large capacity wireless communication networks by using an unlicensed communication wavelength band in cases where the installation of wired communication networks (e.g., copper wires or optical cables) is difficult due to insufficient initial investment cost, or where a rapid deployment of communication infrastructure is required.

In addition, optical wireless communication technology is being extended beyond terrestrial applications into space for purposes such as eliminating Internet shadow areas, establishing and providing services for sixth generation (6G) communication networks, constructing ultra low latency and high capacity low earth orbit (LEO) satellite communication networks, providing space Internet services, and supporting deep space communications.

Among them, free space optical wireless communication may be performed by establishing a communication link through precise long distance point to point line of sight (LoS) alignment between a pair of optical wireless communication terminals that are separated by a distance ranging from several tens of meters to several thousands of kilometers.

However, as the distance of optical wireless communication increases, signal attenuation may occur due to geometric loss caused by beam divergence, and it may become difficult to establish and maintain an optical wireless communication link. In addition, when an obstacle is in the path of the optical wireless communication link, or when absorption, scattering, or turbulence occurs in the atmosphere, degradation or interruption of the optical wireless communication quality may occur.

### SUMMARY OF THE INVENTION

The various embodiments may reconfigure a communication link path or a communication node when a free space optical communication link failure occurs, or when network operation efficiency or optimization is required. In addition, the embodiments may provide a free space optical communication terminal and a method capable of recognizing and resolving failures associated with the terminal or the free space optical communication link.

According to an embodiment disclosed in the present specification, an optical wireless communication terminal may include: an optical wireless transceiver including a transmitter, a receiver, and a communication controller; and an integrated controller configured to monitor an output signal or operation information of the optical wireless transceiver, wherein while the optical wireless transceiver transmits or receives optical wireless data to or from a first optical wireless communication terminal, the integrated controller is configured to monitor whether an abnormality in a communication link or a relay operation condition has occurred, based on at least one criterion among: a received signal strength at the receiver, and a change in a transmission directional angle associated with the transmitter, and wherein, when the integrated controller detects the abnormality in the communication link or the relay operation condition, the integrated controller is further configured to perform a reboot operation of the optical wireless transceiver, re-establish a communication link with the first optical wireless communication terminal after the reboot operation, and retransmit or receive again, by using the optical wireless transceiver, the optical wireless data whose transmission or reception has been interrupted.

In addition, a method for resolving a communication link failure by a first optical wireless communication terminal according to an embodiment disclosed in the present specification may include: an optical wireless transceiver; and the integrated controller configured to monitor an output signal or operation information of the optical wireless transceiver, the method including: monitoring at least one criterion among a received signal strength from a second optical wireless communication terminal and a change in a transmission directional angle toward the second optical wireless communication terminal; verifying, based on the at least one criterion, whether an abnormality in a communication link or a relay operation condition has occurred; performing, when the abnormality in the communication link or the relay operation condition is detected, a rebooting operation of the optical wireless transceiver and re-establishing a communication link with the second optical wireless communication terminal; and retransmitting, using the optical wireless transceiver, optical wireless data whose transmission has been interrupted to the second optical wireless communication terminal.

In addition, a method for resolving a communication link failure by a first optical wireless communication terminal according to an embodiment disclosed in the present specification may include operations of: monitoring a change in at least one of a receiving directional angle and a transmitting directional angle; detecting a relay operation or an abnormality in a communication link when the change in the directional angle with respect to a second optical wireless communication terminal exceeds a specified threshold; performing at least one operation among clearing optical wireless data being transmitted from a memory and performing a rebooting operation, when the relay operation or the abnormality in the communication link is detected; re-establishing a communication link with the second optical wireless communication terminal after performing the at least one operation; and retransmitting or receiving again, through the re-established communication link, the optical wireless data being transmitted.

### BRIEF DESCRIPTION OF DRAWINGS

FIG. 1 illustrates an optical wireless communication terminal using one relay terminal.

FIG. 2 illustrates a configuration diagram of an optical wireless communication terminal according to an embodiment.

FIG. 3 is a diagram illustrating a relay replacement operation when an abnormal condition occurs in a communication link according to an embodiment.

FIG. 4 illustrates a change in a directional angle of the optical wireless communication terminal according to a gimbal rotation.

FIG. 5 illustrates a change in a directional angle of the optical wireless communication terminal caused by a movement of a platform.

FIGS. 6 and 7 illustrate structural diagrams of an optical wireless transceiver.

FIG. 8 illustrates a flowchart of a method for resolving a communication failure based on received-signal monitoring, according to an embodiment.

FIG. 9 illustrates a flowchart of a method for resolving a communication failure based on transmission-directional angle monitoring, according to an embodiment.

FIG. 10 illustrates a flowchart of a method for resolving a communication failure based on platform-movement monitoring, according to an embodiment.

FIGS. 11 and 12 illustrate experimental examples of a triple relay operation using four relay optical wireless communication terminals (\textcircled{1}, \textcircled{2}, \textcircled{3}, and \textcircled{4} in FIG. 11) according to an embodiment.

In connection with the description of the drawings, the same or similar reference numerals may be used to denote the same or similar components.

### DETAILED DESCRIPTION OF THE EMBODIMENTS

An optical wireless communication terminal may further utilize at least one optical wireless communication terminal that performs a relay function between a source optical wireless communication terminal (hereinafter referred to as a “source terminal”) and a destination optical wireless communication terminal (hereinafter referred to as a “destination terminal”), the at least one optical wireless communication terminal being referred to as a “relay terminal”. For example, single or multiple relay optical wireless communication networks may be established.

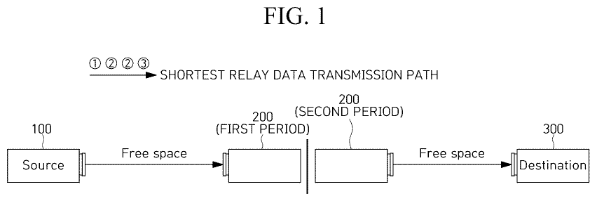

FIG. 1 illustrates an optical wireless communication terminal using one relay terminal.

Referring to FIG. 1, a signal transmitted from a source terminal (a first optical wireless communication terminal (100)) is transmitted to a destination terminal (a third optical wireless communication terminal (300)) through a relay terminal (a second optical wireless communication terminal (200)).

In the relay terminal (a second optical wireless communication terminal (200)) a change in directional angle may occur directional angle at the time of receiving a signal and at the time of relaying the signal. For example, the relay terminal (the second optical wireless communication terminal (200)) may form a communication link with a source terminal (a first optical wireless communication terminal (100)) and may receive and store optical wireless data from the source terminal. The relay terminal (the second optical wireless communication terminal (200)) may release the communication link with the source terminal and may rotate by a specified angle (e.g., 180 degrees) to perform optical alignment with a destination terminal (a third optical wireless communication terminal (300)), and thereafter may transmit the stored optical wireless data to the destination terminal.

As described above, a relay terminal (a second optical wireless communication terminal (200)) must disconnect a communication link with an optical wireless communication terminal with which the communication link has been established, and must adjust its directional angle to form a new optical communication link with another optical wireless communication terminal. In this case, the relay terminal (the second optical wireless communication terminal (200)) may undergoes a communication link connection problem, such as a link connection error or a timeout caused by expiration of an allowable network connection delay time, during a procedure for mutual Internet Protocol (IP) identification and sharing with the new optical wireless communication terminal in the process of forming the new optical communication link.

Moreover, as the process of forming a new optical communication link involves directing toward a new optical wireless communication terminal and performing bidirectional optical alignment, more time is required when the communication distance increases or when the communication environment is poor. Additionally, when the optical wireless communication terminal is mounted on a mobile vehicle (platform), a complex pointing, acquisition, and tracking process must be performed through the mobile vehicle, a gimbal, and a fast steering mirror (FSM), and therefore, the time required for optical alignment becomes even longer and may exceed the allowable network connection delay time.

In related art of wired optical communication technologies based on optical fibers, stable network connections are guaranteed, and therefore, discontinuities or long interruptions in communication links, such as those occurring in optical wireless communication systems employing relay terminals, have not occurred.

However, in case of employing a relay terminal in an optical wireless communication system, when the relay terminal (the second optical wireless communication terminal (200)) disconnects a communication link with an optical wireless communication terminal (a source terminal, a first optical wireless communication terminal (100)) with which the communication link has been established, and establish a communication link with a new optical wireless communication terminal (a destination terminal, a third optical wireless communication terminal (300)), problems such as connection failure, timeout due to expiration of an allowable delay period, inability of Internet Protocol (IP) recognition, and network identification failure may occur, thereby making it impossible to perform normal optical wireless communication.

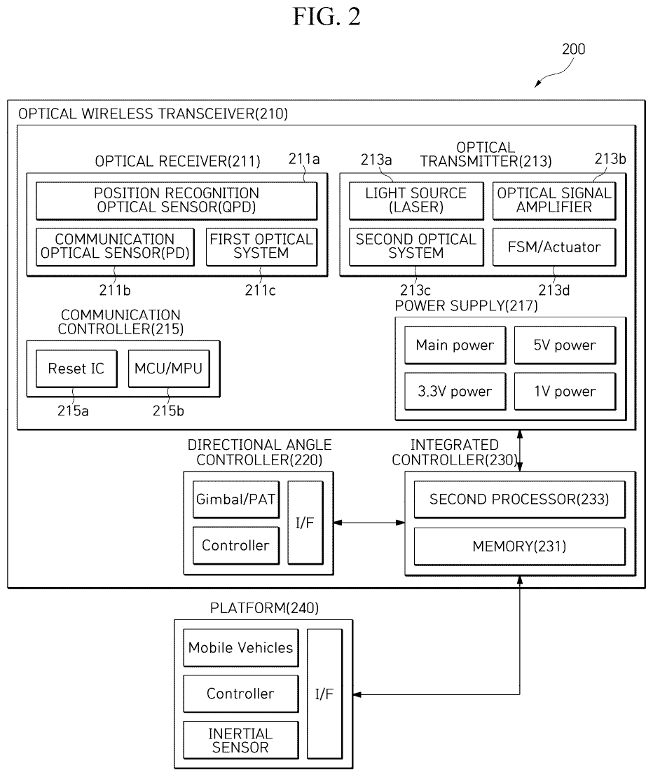

FIG. 2 illustrates a configuration diagram of an optical wireless communication terminal according to an embodiment.

Referring to FIG. 2, an optical wireless communication terminal (200) according to an embodiment may include an optical wireless transceiver (210), a directional angle controller (220), and an integrated controller (230). The optical wireless communication terminal (200) may be mounted on a platform (240).

In FIG. 2, an example in which the optical wireless communication terminal (200) operates as a relay terminal is described. The optical wireless communication terminal (200) (the relay terminal (200) of FIG. 1) may, during a reception period (a first period), be oriented toward a first optical wireless communication terminal (100) and may receive and store optical wireless data from the first optical wireless communication terminal (100) through free space optical wireless communication. Thereafter, during a transmission period (a second period), the optical wireless communication terminal (200) may rotate to face a third optical wireless communication terminal (300) and may transmit the stored optical wireless data to the third optical wireless communication terminal (300). When the optical wireless communication terminal (200) operates as the relay terminal of FIG. 1, the optical wireless communication terminal (200) receives the optical wireless data while oriented toward the first optical wireless communication terminal (100), and then transmits the optical wireless data to the third optical wireless communication terminal (300) while rotated to be oriented toward the third optical wireless communication terminal (300).

Accordingly, in the process in which the optical wireless communication terminal (200) disconnects a communication link formed with the first optical wireless communication terminal (100) and newly forms a communication link with the third optical wireless communication terminal (300), a communication failure, such as connection failure, timeout due to expiration of an allowable delay period, inability of Internet Protocol (IP) recognition, or network identification failure, may occur.

In preparation for this, an optical wireless communication terminal (200) according to an embodiment may prevent a communication failure by performing a specified rebooting operation during a communication link switching process. The specified rebooting operation may include, for example, at least one of resetting and restarting a communication controller (215), powering off and then supplying power, restarting an operating system, and performing a flush operation of a memory or buffer that clears information on terminals forming existing optical wireless communication links, such as Internet Protocol (IP) or network identifiers. The flush of memory or buffer may include flushing memory of an opposite side optical wireless communication terminal (200) that receives optical wireless data from the optical wireless communication terminal (200). The memory flush may not completely delete optical wireless data stored in a memory (231) but may delete optical wireless data temporarily stored for transmission in a buffer (or volatile memory), transmission records, and information of terminals forming existing optical wireless communication links.

According to an embodiment, the optical wireless transceiver (210) may include an optical receiver (211), an optical transmitter (213), a communication controller (215), and a power supply (217).

The optical receiver (211) may include a position sensing optical sensor (QPD), a communication optical sensor (PD), and a first optical system (211c). The first optical system (211c) may include a lens, a filter, and wavelength division multiplexing (WDM) components.

The optical transmitter (213) may include a light source (laser), an optical signal amplifier (213b), a second optical system (213c) (for example, wavelength division multiplexing (WDM), a beam splitter, a bandpass filter, and a lens), and a directional angle adjustment element (213d). The optical signal amplifier (213b) may include, for example, a semiconductor optical amplifier (SOA), an erbium doped fiber amplifier (EDFA), or the like. The directional angle adjustment element (213d) may include a fast/fine steering mirror (FSM), an actuator, and a micro-electro-mechanical system (MEMS).

The communication controller (215) may include a reset integrated chip (IC) and a first processor (215b). The first processor (215b) may perform operation and control of the optical wireless transceiver (210). The first processor (215b) may include, for example, a microcontroller unit (MCU), a microprocessor unit (MPU), an on-board processor (OBP), or an on-board computer (OBC).

The power supply (217) provides power to the communication controller (215), the optical receiver (211), and the optical transmitter (213).

The directional angle controller (220) may include a driving unit (for example, a gimbal or a pan-and-tilt (PAT) mechanism) for controlling a wide directional (transmission) angle (or a wide reception angle) of the optical wireless transceiver (210), and a controller for controlling the driving unit. The directional angle controller (220) may provide directional angle information of the optical wireless transceiver (210) to the integrated controller (230).

According to an embodiment, the platform (240) may include mobile vehicles and a controller for controlling movement of the mobile vehicles. The platform (240) may be connected to the integrated controller (230) and may provide motion information of the platform (240) to the integrated controller (230) through a specified interface (a communication channel or a signal line). For example, the platform (240) may be equipped with an inertial sensor, and the controller of the platform (240) may provide the integrated controller (230) with attitude information (for example, directional angle and rotation speed) and movement information (for example, acceleration, deceleration, and travel path) of the platform (240) detected by the inertial sensor. In another example, the integrated controller (230) may also receive the attitude information and movement information of the platform (240) through the inertial sensor installed in the platform (240).

According to an embodiment, the integrated controller (230) may include a memory (231) and a second processor (233). The memory (231) may store optical wireless data that has been received or is to be transmitted. The second processor (233) may monitor, control, and operate at least one component of the optical wireless transceiver (210) and the directional angle controller (220). In addition, the integrated controller (230) may monitor an angular change, an attitude change, and movement information of the platform (240) based on motion information of the platform (240).

According to an embodiment, the integrated controller (230) may check for an abnormality in a communication link while transmitting optical wireless data stored in the memory (231) to a third optical wireless communication terminal (300) through free space optical wireless communication using the optical wireless transceiver (210).

According to one embodiment, the integrated controller (230) may monitor a signal strength received by the optical receiver (211) and a change in a precise directional angle associated with the optical transmitter (213). The integrated controller (230) may determine that there is an abnormality in a communication link when at least one of the following conditions is satisfied: the signal strength is below a reference level, a change in the precise directional angle is more than a first threshold, or the precise directional angle has changed by more than a second threshold. The signal received by the optical receiver (211) may be, for example, a response signal from the third optical wireless communication terminal (300) in response to a signal transmitted through the optical transmitter (213).

In one embodiment, the integrated controller (230) may detect a received signal strength based on signal strength detected by a communication optical sensor (PD) and a position recognition optical sensor (QPD). The integrated controller (230) may monitor fine receiving angle information and movement direction information detected by the position recognition optical sensor (QPD).

The first threshold θ_{C} may be set, for example, within a maximum angular range (critical angle) in which a transmitted beam does not deviate from an aperture of an optical wireless communication terminal located at a receiving point (remote) beam displacement (L_{D}) in accordance with a distance (D) between optical wireless communication terminals. The beam displacement (L_{D}) may be occurred at as a result of a two-axis directional angle variation (θ) generated by FSM/actuator/MEMS elements and a directional angle controller included in a local optical wireless communication terminal. However, the first threshold may vary depending on the distance (D) between the optical wireless communication terminals and the size of the transmitted beam within the maximum angular range. The beam displacement (L_{D}) of an output optical signal according to the directional angle variation may be calculated by the following Equation 1.

$${L}_{D} = D \times tan θ \qquad [ Equation 1 ]$$

Here, θ denotes a directional angle variation, D denotes a communication distance between optical wireless communication terminals, and L_{D} denotes a beam displacement of an output optical signal at a receiving point (remote) according to the directional angle variation.

The second threshold may be determined as at least one value according to a permissible receiving angle range by the position, structure, and optical characteristics of a third optical wireless communication terminal (300), which is a target to which the optical wireless communication terminal (200) transmits optical wireless data. For example, the permissible receiving angle range (critical angle-of-incidence, θ_{C.AOI}) of the third optical wireless communication terminal may represent an angle of incidence within which an optical signal entering the aperture of the optical wireless communication terminal may pass through an optical system and finally reach a communication optical sensor (PD), and may vary depending on the optical structure and configuration of the optical wireless communication terminal.

Accordingly, by monitoring whether a two-axis directional angle variation (θ) generated by FSM, actuator, and MEMS elements and a directional angle controller included in a local optical wireless communication terminal is greater than the second threshold, it may be checked whether a process of establishing a relay optical wireless communication link with another optical wireless communication terminal for forming a new link is in progress.

When the integrated controller (230) detects an abnormality in a communication link, it may reboot the optical wireless transceiver (210). For example, during detection of the communication link abnormality and a reboot operation, the integrated controller (230) may perform at least one of the following operations on the communication controller (215): reset and restart, power-off and power-on, restart of an operating system, and flush operation of memory/buffer to clear received data and information on an existing optical wireless communication link (such as IP and network identifiers).

Thereafter, the integrated controller (230) may re-establish a communication link with the third optical wireless communication terminal (300) by using the optical wireless transceiver (210). The integrated controller (230) may retransmit optical wireless data that failed to be transmitted due to the abnormality in the communication link by using the optical wireless transceiver (210). For example, when a total of 100 GB of optical wireless data is to be transmitted and 60 GB thereof has been successfully transmitted while 40 GB remains, the integrated controller (230) may retransmit the entire 100 GB of optical wireless data from the beginning, or may transmit the remaining 40 GB starting from the portion that failed to be transmitted by additionally employing delay tolerant networking (DTN) technology in the optical wireless transceiver (210).

According to one embodiment, the integrated controller (230) may obtain directional angle information from the directional angle controller (220) and may monitor a wide directional angle change of the optical wireless transceiver (210) based on the directional angle information. When the wide directional angle change exceeds a reference level, the integrated controller (230) may perform a reboot operation of the optical wireless transceiver (210). The integrated controller (230) may perform optical alignment again with the third optical wireless communication terminal (300) by adjusting the wide directional angle of the directional angle controller (220) and then adjusting a precise directional angle of the optical transmitter (213) through the optical wireless transceiver (210), and may retransmit optical wireless data.

According to one embodiment, the integrated controller (230) may monitor an angular change of the platform (240) based on movement information from an inertial sensor and may determine whether the angular change of the platform (240) is equal to or greater than a third threshold. When it is determined that the angular change of the platform (240) is equal to or greater than the third threshold, the integrated controller (230) may reboot the optical wireless transceiver (210) and may perform optical alignment with the third optical wireless communication terminal (300) again. For example, after rebooting the optical wireless transceiver (210), the integrated controller (230) may adjust a wide directional angle of the directional angle controller (220) so as to correspond to the angular change of the platform (240), and then may adjust a precise directional angle of the optical wireless transceiver (210). The third threshold, for example, may be preset to a value at which an abnormality in free space optical wireless communication with another optical wireless communication terminal occurs due to motion variation such as an angular change or positional displacement.

The optical wireless transceiver (210) may further include a reset IC configured to activate a reboot function of the communication controller (215). The integrated controller (230) may perform the reboot function of the optical wireless transceiver (210) by applying a reset signal to the reset IC when at least one of specified conditions is satisfied.

The integrated controller (230) may further include an output device for notifying a communication abnormality (or communication failure). In this case, the integrated controller (230) may provide a notification of the communication failure through the output device and may perform a reboot operation by detecting a reset signal according to a user's manipulation after the user confirms the notification of the communication failure.

In the above described embodiment, the case in which the optical wireless communication terminal (200) operates as a relay terminal and responds to a communication failure has been described as an example. However, the scope is not limited thereto. For example, even when the optical wireless communication terminal (200) does not operate as a relay terminal, if it detects a communication failure with a terminal that is a receiving target of optical wireless data, it may perform the above described reboot operation to cope with the communication failure. In this case, when a directional angle change according to position recognition data (the direction or directional angle of an incident signal) becomes equal to or greater than a first threshold (or a second threshold), or when a received signal strength remains below an allowable signal strength according to characteristics of the optical wireless communication terminal (200) for a time period equal to or longer than a reference time, it may be determined that a long-term optical communication link disconnection, abnormality, or relay operation condition has occurred.

In the above described embodiment, an example has been described in which the optical wireless communication terminal (200) autonomously monitors a received signal strength of a communication optical sensor, a received signal strength of a position recognition optical sensor, a precise directional angle, a wide directional angle, and movement of the platform (240) to identify an abnormality in an optical communication link or a relay operation condition, and performs a reboot operation accordingly. However, the scope is not limited thereto. For example, the optical wireless communication terminal (200) may receive a reboot operation request message from another optical wireless communication terminal that has received optical wireless data (or that is to transmit optical wireless data), and may perform a reboot operation after confirming an abnormality in an optical communication link or a relay operation condition according to the request. Additionally, the optical wireless communication terminal (200) may request a flush of a data storage space for optical communication data being transmitted to another optical wireless communication terminal in response to a communication link abnormality or a relay operation condition.

Meanwhile, the optical wireless communication terminal (200) may perform a reboot operation in the following manner.

According to one embodiment, the optical wireless communication terminal (200) may perform a reboot operation in a physical manner by a user. The optical wireless communication terminal (200) may display a communication link abnormality or a relay operation condition through an output device (not shown), and the user may directly manipulate a button or a switch. In this case, when a reset signal is applied to a reset IC provided in the optical wireless communication terminal (200), the optical wireless transceiver (210) may perform a reset, the power supply (217) may be turned off and on, the operating system may be reset and restarted, and may flush the storage space (memory/buffer) of the optical wireless communication terminal (200).

According to another embodiment, the optical wireless communication terminal (200) may perform a reboot operation based on a user command. For example, when a user detects a communication link abnormality or a relay operation condition of the optical wireless communication terminal (200), the user may directly transmit a command to the local optical wireless communication terminal (i.e., the optical wireless communication terminal (200)). In another example, the user may cause a remote optical wireless communication terminal (e.g., the third optical wireless communication terminal (300)) to confirm a relay operation condition of the local optical wireless communication terminal and to perform preparation for relay optical wireless communication, by transmitting a state information signal and a command in a user-defined field to the remote optical wireless communication terminal (e.g., the third optical wireless communication terminal (300)). The remote optical wireless communication terminal may then perform a reset of the optical wireless transceiver, perform an on/off operation of the power supply, reset and restart the operating system, and flush the storage space (memory/buffer) of the optical wireless communication terminal (200). The user command may be transmitted between the local (sender) and the remote (receiver) terminals by including state information and a reset packet in a user-defined field of an Ethernet OSI (Open Systems Interconnection) second-layer frame, or by including state information and reset information in a user-defined field of a TCP (OSI fourth layer) or UDP (OSI fifth layer) protocol.

According to one embodiment, the local optical wireless communication terminal (i.e., the optical wireless communication terminal (200)) may automatically perform a reboot operation based on monitoring data from the optical receiver (211), the optical transmitter (213), the directional angle controller (220), and the platform (240). The local and remote optical wireless communication terminals (e.g., 200 and 300) may further utilize results determined based on the monitoring data values to perform a reset of the communication controller (215), an on/off operation of the power supply (217), a reset and restart of the operating system, and a flush of the storage space, through either a user command or a manual switch operation.

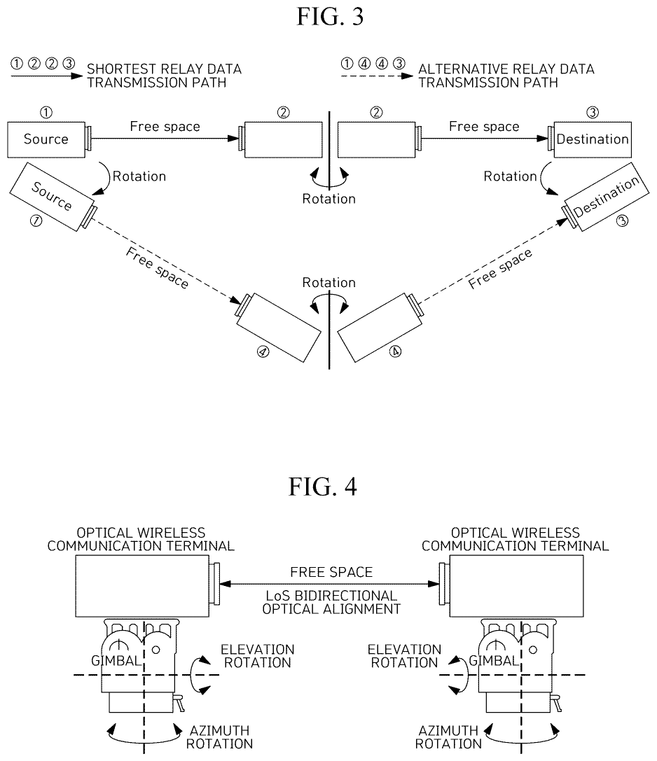

FIG. 3 is a diagram illustrating a relay replacement operation in the event of a communication link abnormality according to an embodiment.

Referring to FIG. 3, a source optical wireless communication terminal (\textcircled{1}) may perform optical wireless data communication with a destination optical wireless communication terminal (\textcircled{3}) through a single relay process by way of a relay terminal (i.e., the optical wireless communication terminal \textcircled{2} or \textcircled{4}). For example, free space optical data transmission may be carried out along the shortest path (\textcircled{1}→\textcircled{2}→\textcircled{3}) from the source optical wireless communication terminal (\textcircled{1}) to the destination optical wireless communication terminal (\textcircled{3}). In addition, when a failure occurs in free space optical communication (for example, obstruction caused by an obstacle or signal loss due to a communication channel), relay transmission may be performed through an alternative path (\textcircled{1}→\textcircled{4}→\textcircled{3}).

First, in the case of optical wireless data transmission through the shortest path (\textcircled{1}→\textcircled{2}→\textcircled{3}), the optical wireless communication terminal \textcircled{2} receives data from the optical wireless communication terminal \textcircled{1}. The optical wireless communication terminal \textcircled{2} then stores the received data in its internal storage space and rotates toward the optical wireless communication terminal \textcircled{3} in order to transmit the data thereto. However, during the rotation of the optical wireless communication terminal \textcircled{2} and the process of performing new bidirectional optical alignment with the optical wireless communication terminal \textcircled{3}, a disconnection or interruption of the optical wireless communication link may occur. In addition, during the procedures for mutual IP identification and sharing with the optical wireless communication terminal \textcircled{3}, a link connection error or a timeout due to a network connection delay may occur. As a result, the optical wireless communication terminal \textcircled{2} may be required to perform operations such as resetting the communication controller, turning the power supply on and off, and resetting and restarting the operating system to establish a stable relay link with the optical wireless communication terminal \textcircled{3}.

Next, after relay optical wireless data transmission has been performed through the shortest path, optical wireless data transmission through the alternative path (\textcircled{1}→\textcircled{4}\textcircled{3}) may be carried out as follows.

The optical wireless communication terminal \textcircled{1} rotates toward the optical wireless communication terminal \textcircled{4} for optical wireless communication, and establishes a communication link with the optical wireless communication terminal \textcircled{4} through a bidirectional optical alignment process.

The optical wireless communication terminal \textcircled{1}, which has previously formed a communication link and performed data transmission with the optical wireless communication terminal \textcircled{2}, may perform new bidirectional optical alignment with the optical wireless communication terminal \textcircled{4} located on the alternative path. During this process, a disconnection or interruption of the optical wireless communication link may occur, and a communication link connection problem may arise due to a link connection error or a timeout caused by a network connection delay during procedures for mutual IP identification and sharing with the optical wireless communication terminal \textcircled{4}. To prevent this, the optical wireless communication terminal \textcircled{1} may be required to perform operations such as resetting the communication unit, turning the power supply on and off, resetting and restarting the operating system, and flushing the memory/buffer storing information (e.g., IP addresses, network identifiers, etc.) of the terminal that previously formed the optical wireless communication link, in order to establish a stable relay link with the optical wireless communication terminal \textcircled{4}.

In addition, the optical wireless communication terminal \textcircled{4} stores data received from the optical wireless communication terminal \textcircled{1} and rotates in order to relay and transmit the stored optical wireless data to the optical wireless communication terminal \textcircled{3}. At this time, the optical wireless communication terminal \textcircled{3}also disconnects an existing communication link previously formed with the optical wireless communication terminal \textcircled{2} and rotates toward the optical wireless communication terminal \textcircled{4} to establish a communication link through a bidirectional optical alignment process. In this case, before forming a new relay optical wireless communication link, both the optical wireless communication terminals \textcircled{3} and \textcircled{4} may perform operations such as resetting the communication unit, turning the power supply on and off, resetting and restarting the operating system, and flushing the memory/buffer storing information (e.g., IP addresses, network identifiers, etc.) of the terminal that previously formed the optical wireless communication link. Accordingly, the optical wireless communication terminals \textcircled{1}, \textcircled{2}, \textcircled{3}, and \textcircled{4} may form a stable relay optical wireless communication link by performing at least one of the various reboot operations described above prior to the establishment of the new relay optical wireless communication link.

Furthermore, the configuration of communication link disconnection, reconnection, and data relay transmission between relay optical wireless communication terminals may be extended to a multiple relay optical wireless communication system and network by expanding the structure illustrated in FIG. 3.

As such, the optical wireless communication terminal (200) according to an embodiment may be utilized to establish a stable relay optical wireless communication link in preparation for situations where an obstacle is located along the optical wireless communication link path, where optical wireless communication quality is degraded or interrupted due to atmospheric loss, or where it is necessary to increase the optical wireless communication distance and construct an optical wireless communication network over a wide area.

In addition, the optical wireless communication terminal (200) according to an embodiment may resolve optical wireless data loss or omission errors that occur due to the inherent characteristics of optical wireless communication, which are not generally found in conventional wired or wireless communication systems.

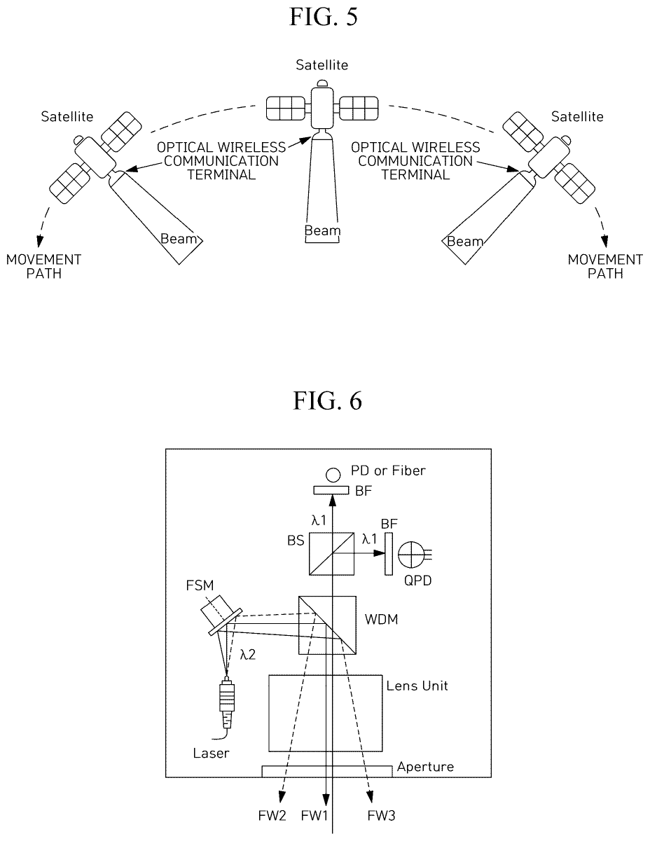

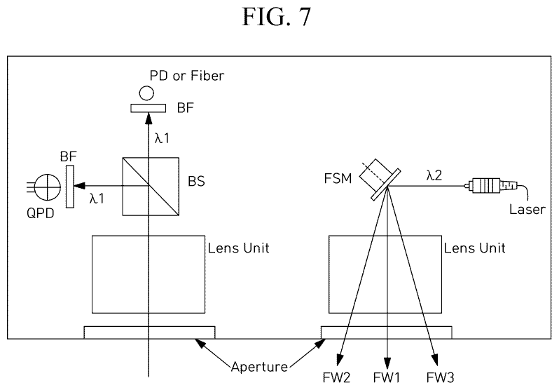

Hereinafter, with reference to FIGS. 4 and 5, an operation for monitoring and recognizing a situation in which a relay terminal (a terminal including an optical wireless transceiver having an optical transmitter and an optical receiver) disconnects an established optical wireless communication link and rotates a gimbal (the directional angle controller (220)) or rotates/moves a platform (240) in order to transmit data to a new relay terminal will be described.

FIG. 4 illustrates a change in the directional angle of an optical wireless communication terminal according to the rotation of the gimbal on which the optical wireless communication terminal is mounted.

As illustrated in FIG. 4, the optical wireless communication terminal mounted on the gimbal can be directed toward the entire three-dimensional space according to a combination of elevation rotation and azimuth rotation of the gimbal. In the case of an optical wireless communication terminal (200) that operates while being fixed at a certain point, the integrated controller (230) may recognize that a directional angle control and reconnection process for relay operation, such as that shown in FIG. 3, is being performed when it detects a change amount exceeding a third threshold being determined for the gimbal.

In this case, the integrated controller (230) may perform operations such as resetting the communication controller (215), turning the power supply (217) on and off, resetting and restarting the operating system, and flushing the memory or buffer in which information (e.g., IP addresses, network identifiers, etc.) of a terminal that has formed an existing optical wireless communication link is stored. The directional angle controller (220) may include at least some components of a gimbal, a PAT (Pan and Tilt) device, a gear, and a motor. The directional angle controller (220) may be combined with the optical wireless communication terminal (200) to apply any system capable of controlling the wide directional angle of the optical wireless communication terminal (200).

FIG. 5 illustrates a change in the directional angle of the optical wireless communication terminal caused by movement of the platform. The platform (240) includes mobile vehicles equipped with the optical wireless communication terminal (200), capable of supporting motion such as attitude (or, posture) control or position movement on the ground, in the air, in space, on the water, or underwater. In FIG. 5, the platform (240) is illustrated as a satellite by way of example. However, the present disclosure is not limited thereto. For example, the platform (240) may include, in addition to satellites, flight vehicles, spacecraft, balloons, cars, ships, and submarines.

Referring to FIG. 5, the optical wireless communication terminal (200) may recognize a relay operation by monitoring the motion of the platform (240) (in FIG. 5, a satellite), such as attitude changes (rotation) and trajectory changes (movement). When the attitude change or movement of the mobile vehicle is detected to exceed a third threshold, the optical wireless communication terminal (200) may recognize and determine the situation as a relay operation and perform a specified reboot operation such as resetting the communication controller (215), turning the power supply (217) on and off, resetting and restarting the operating system, and flushing the memory or buffer storing information (e.g., IP addresses, network identifiers, etc.) of a terminal that has formed an existing optical wireless communication link so as to prepare for and enable the connection of a new relay optical wireless communication link.

In addition, the quality degradation of optical wireless communication link or temporary disconnections may also occur in a reconnection or link recovery situation such as fine vibration or momentary trajectory deviation of the platform 240 (or by a change in the directional angle below the third threshold confirmed based on motion information). In this regard, the optical wireless communication terminal 200 may distinguish a reconnection/link recovery situation rather than a relay situation based on the output information of a communication optical sensor (PD) and a position recognition optical sensor (QPD) included in the optical receiver (211). Thus, if necessary, the optical wireless communication terminal (200) may perform a flush operation on the memory or buffer so that all previously received data are cleared and data reception is restarted from the beginning.

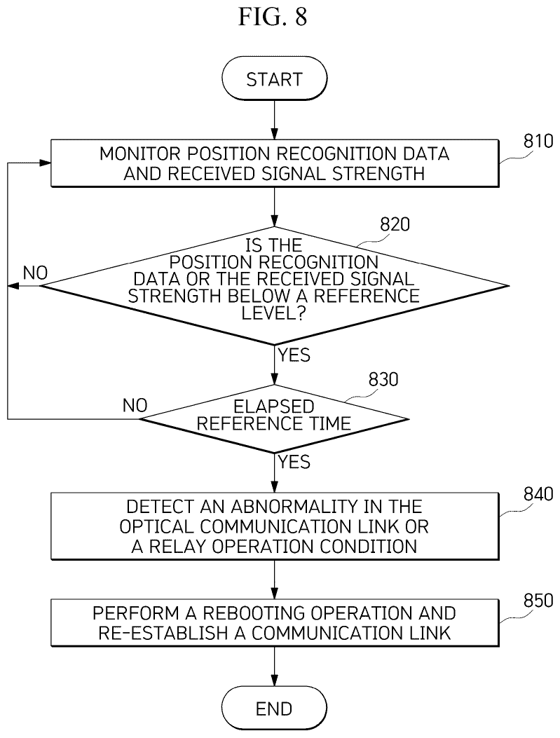

FIGS. 6 and 7 illustrate structural diagrams of the optical wireless communication device.

Referring to FIGS. 6 and 7, the optical receiver (211) includes a position recognition optical sensor (QPD) and a communication optical sensor (PD), and the optical transmitter (213) may include an FSM for precise directional angle control. Through a WDM (Wavelength Division Multiplexing) filter, the received optical signal (λ₁) and the transmitted optical signal (λ₂) pass through at least one lens unit and at least one aperture. FIG. 6 illustrates an example of a monostatic structure in which the optical transmitter and optical receiver share the lens unit and the aperture, while FIG. 7 illustrates an example of a bistatic structure in which the optical transmitter and optical receiver do not share the lens unit and the aperture.

In FIGS. 6 and 7, the position recognition optical sensor (QPD) may recognize the presence or absence and the incident direction of an optical signal (λ₁) incident on the optical wireless communication terminal (200). The position recognition optical sensor (QPD) may perform optical alignment and counterpart tracking by recognizing the movement and directional angle change of the opposite optical wireless communication terminal.

The communication optical sensor (PD) may employ both a direct detection method that directly detects an incident optical signal (λ₁) and a detection method that amplifies an optical signal collected through an optical fiber. For example, the communication optical sensor (PD) may be an optoelectronic device that converts an optical signal into an electrical signal through optical-to-electrical conversion, such as an avalanche photodiode (APD) or a PIN photodiode (P-i-N PD). The optical wireless communication device (210) may adjust the ratio of the incident optical signal (λ₁) directed toward the position recognition optical sensor (QPD) and the communication optical sensor (PD) by controlling the reflectance and transmittance of the beam splitter (BS).

Meanwhile, the position recognition optical sensor (QPD) may monitor the position and rotation information of the opposite optical wireless communication terminal according to the rotation of the directional angle controller (220) and the attitude change or movement of the platform (240) during the formation of a relay optical wireless communication link. In addition, the position recognition optical sensor (QPD) and the communication optical sensor (PD) may detect a rapid decrease in the received optical signal (λ₁) level when a misalignment or deviation occurs. When the alignment link is completely misaligned, the position recognition optical sensor (QPD) and the communication optical sensor (PD) may detect background noise-level or zero-level signals

These characteristics may enable the remote relay optical wireless communication terminal to detect whether the directional angle controller (220) has changed its angle or whether the platform (240) has changed its attitude or moved, in order to form a new relay link. The remote terminal may then recognize and determine the situation by double-checking the optical wireless communication terminal (200).

The directional angle control element (213d) may include an FSM, an actuator, and a MEMS element. The FSM is a device that precisely and rapidly adjusts the traveling direction of the output optical signal (λ₂) through fine two-axis angle control. Actuators and MEMS elements may further be used for precise directional angle control. When forming a relay optical wireless communication link between optical wireless communication terminals located at a long distance from each other, a communication link may be established with the opposite (remote) optical wireless communication terminal by connecting the output optical signal (λ₂) through fine angle control of the FSM, actuator, or MEMS element, without attitude control or movement of the directional angle controller (220) or the platform (240).

The integrated controller (230) may monitor the position recognition data output from the position recognition optical sensor (QPD) and the communication optical sensor (PD), as well as changes in the output signal intensity of each sensor. When the position recognition data or the output signal intensity decreases below a reference level, or when the communication optical sensor (PD) fails to receive an optical signal or maintains the output signal of a significantly low level (for example, below the reference level) for a specified period of time, the integrated controller (230) may recognize that a relay situation or a prolonged optical communication link interruption or abnormal condition has occurred.

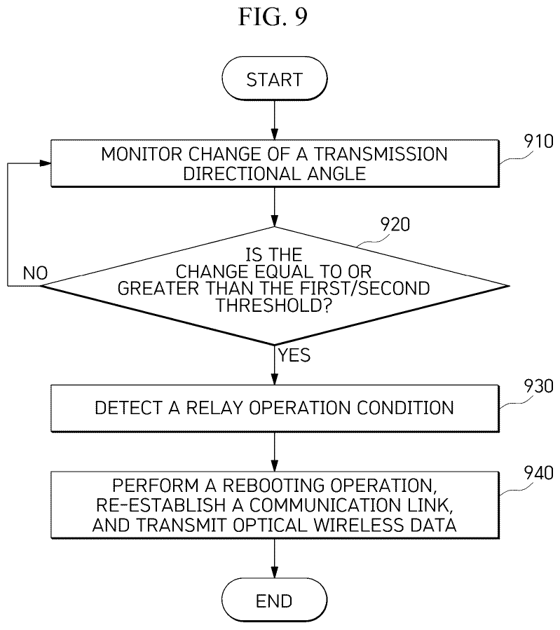

FIG. 8 illustrates a flowchart of a method for preventing and resolving communication failures according to reception signal monitoring in accordance with an embodiment of the present disclosure.

Referring to FIG. 8, in operation 810, the optical wireless communication terminal (200) may monitor the signal strength received from another optical wireless communication terminal and the position recognition data.

In operation 820, the optical wireless communication terminal (200) may determine whether the position recognition data or the received signal strength is below a reference level. For example, the optical wireless communication terminal (200) may use the position recognition optical sensor (QPD) and the communication optical sensor (PD) to respectively check the position recognition data and the signal strength received from a receiving side that receives the optical wireless data, and may determine whether each of the position recognition data and the received signal strength is below its respective reference level. In this case, the position recognition data and the received signal strength may be compared with the same threshold or with different thresholds.

In operation 830, when it is determined that the signal strength is below the reference level, the optical wireless communication terminal (200) may check the elapsed time for which the signal strength remains below the reference level and may determine whether the elapsed time exceeds a reference time.

In operation 830, when it is confirmed that the duration exceeds the reference time period, the optical wireless communication terminal (200) may detect that a communication link abnormality or a relay operation condition has occurred in operation 840.

In operation 850, the optical wireless communication terminal (200) may perform a rebooting operation on the optical wireless transceiver (210), re-establish the communication link, and retransmit the optical wireless data that was interrupted during transmission, either from the beginning or from the portion where transmission failed.

Meanwhile, in operation 830, when it is confirmed that the elapsed time for which the signal strength remains below the reference level is less than the reference time, the optical wireless communication terminal (200) may determine that the situation corresponds to a temporary quality degradation of optical communication link and may return to operation 810 to continuously monitor change in the position recognition data and the received signal strength through the optical receiver (211).

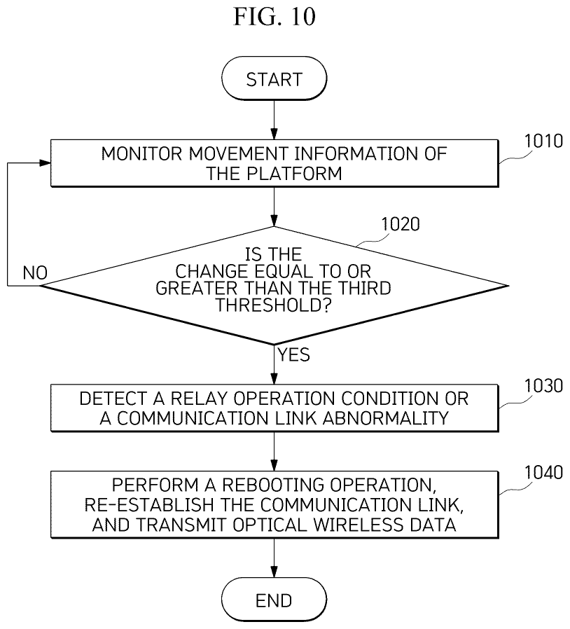

FIG. 9 illustrates a flowchart of a method for preventing and resolving communication failures based on transmission directional angle monitoring in accordance with an embodiment.

Referring to FIG. 9, in operation 910, the optical wireless communication terminal (200) may monitor changes in the transmission directional angle. For example, the optical wireless communication terminal (200) may monitor changes in the directional angle of the FSM or actuator of the optical transmitter (213). In another example, the optical wireless communication terminal (200) may monitor wide directional angle changes (elevation angle and azimuth angle) caused by the directional angle controller (220) (PAT or gimbal).

In operation 920, the optical wireless communication terminal (200) may determine whether the change in the transmission directional angle (precise directional angle or wide directional angle) toward another optical wireless communication terminal exceeds a specified first threshold (or second threshold). For example, the first threshold may be determined as at least one value according to the optical characteristics of the receiving optical wireless communication terminal (200) (for instance, the third optical wireless communication terminal (300) shown in FIG. 1). The second threshold may be determined as at least one value according to the beam divergence angle (which determines beam size at the receiving location) of the transmitting optical wireless communication terminal (200) (for example, the optical wireless communication terminal (200) corresponding to the second period in FIG. 1) and the position of the receiving optical wireless communication terminal (200), such as the third optical wireless communication terminal (300) in FIG. 1.

In operation 930, when it is confirmed that the change in the transmission directional angle exceeds the specified threshold, the optical wireless communication terminal (200) may detect that a relay operation condition has occurred.

In operation 940, when the optical wireless communication terminal (200) detects that the relay operation condition has occurred, it may perform a rebooting operation, re-establish the communication link, clear (flush) data stored in the memory/buffer related to existing optical wireless communication link formation information (such as IP addresses or network identifiers), and then transmit the optical wireless data.

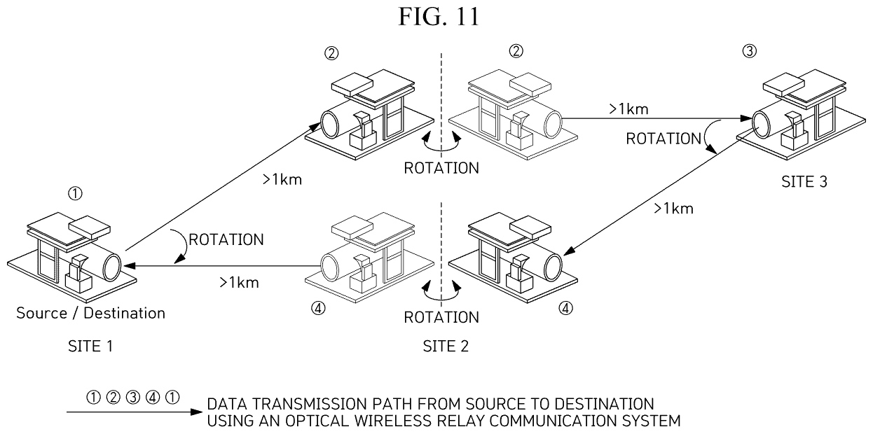

FIG. 10 illustrates a flowchart of a method for preventing and resolving communication failures based on movement monitoring of a mounted platform in accordance with an embodiment.

Referring to FIG. 10, in operation 1010, the optical wireless communication terminal (200) may monitor movement information of the mounted platform (240) on which it is installed. For example, the optical wireless communication terminal (200) may monitor positional or angular changes of the mounted platform (240) based on operation information of the platform 240 and motion information detected by an inertial sensor provided in the platform (240).

In operation 1020, the optical wireless communication terminal (200) may determine whether the movement change of the platform (240) exceeds a third threshold. For example, the optical wireless communication terminal (200) may check whether the movement distance or rotation angle of the platform 240 exceeds the respective third threshold. The third threshold may be set to a level at which free space optical communication with another optical wireless communication terminal is adversely affected due to movement changes.

In operation 1030, when it is confirmed that the movement change of the platform (240) exceeds the third threshold, the optical wireless communication terminal (200) may detect that a relay operation condition or a communication link abnormality has occurred.

In operation 1030, when the optical wireless communication terminal (200) detects that the relay operation condition or the communication link abnormality has occurred, the terminal 200 may, in operation 1040, perform a rebooting operation, re-establish the communication link, clear (flush) data stored in the memory/buffer related to existing optical wireless communication link formation information (such as IP addresses or network identifiers), and then transmit the optical wireless data. In this case, the optical wireless communication terminal 200 may adjust its directional angle (or perform optical alignment) toward another optical wireless communication terminal (200) to reflect the movement change of the mounted platform (240).

According to the above described embodiments, the optical wireless communication terminal (200) may perform the operations of FIGS. 8 through 10 simultaneously or sequentially. In this case, the optical wireless communication terminal (200) may monitor attitude control (angle) or movement changes of the platform (240), and simultaneously or sequentially monitor changes in received signal strength to determine whether such changes correspond to a temporary degradation in optical wireless communication link quality caused by vibrations or oscillations of the platform (240), or whether they correspond to a relay operation condition or a prolonged optical communication link disconnection or abnormality.

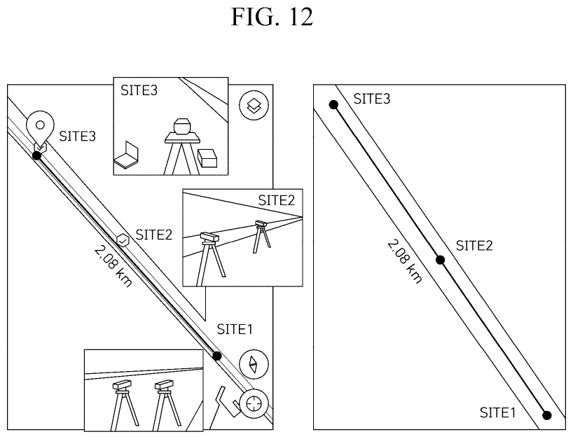

FIGS. 11 and 12 illustrate an experimental example of a triple relay operation using four relay optical wireless communication terminals (\textcircled{1}, \textcircled{2}, \textcircled{3}, and \textcircled{4}) in accordance with an embodiment.

In FIGS. 11 and 12, all four relay optical wireless communication terminals were utilized for optical wireless data relay transmission. In particular, the first relay optical wireless communication terminal (\textcircled{1}) located at SITE 1 was used as both a source terminal and a destination terminal, such that transmission of the relay optical wireless data was performed in the order of \textcircled{1} (Source)→\textcircled{2}→\textcircled{3}→\textcircled{4}→\textcircled{1} (Destination).

As shown in FIG. 12, by employing four relay optical wireless communication systems, a relay optical wireless communication network can be established on an actual field site over a total distance of more than 4 km (a one-way distance of more than 2 km), thereby enabling data relay transmission.

Various embodiments of the present disclosure and the terms used herein are not intended to limit the technical features described in this document to specific embodiments, and it should be understood that they include various modifications, equivalents, or alternatives of the described embodiments. In the drawings and related descriptions, similar reference numerals may be used to designate similar or corresponding components. A singular form of a noun referring to an item may include one or more of such items, unless the context clearly indicates otherwise. As used herein, expressions such as “A or B,” “at least one of A and B,” “at least one of A or B,” “A, B, or C,” “at least one of A, B, and C,” and “at least one of A, B, or C” are intended to include any one of the listed items or any combination thereof. Terms such as “first,” “second,” “primary,” or “secondary” are used merely to distinguish one component from another, and do not imply any limitation with respect to importance, order, or sequence. When an element (for example, a first element) is referred to as being “coupled” or “connected” to another element (for example, a second element), with or without the modifiers “functionally” or “communicatively,” this means that the element may be directly (e.g., by a wired connection), wirelessly, or indirectly (e.g., through another element) connected to the other element.

The term “module,” as used herein, may include a unit implemented in hardware, software, or firmware, and may be interchangeably used with terms such as “logic,” “logical block,” “component,” or “circuit.” A module may refer to an integrated part or a minimum unit (or a portion thereof) that performs one or more functions. For example, in an embodiment, a module may be implemented in the form of an ASIC (Application-Specific Integrated Circuit).

Various embodiments of the present disclosure may be implemented as software (e.g., a program) including one or more instructions stored in a storage medium (e.g., an internal memory, an external memory, or the memory (231)) readable by a machine (e.g., an electronic device). For example, a processor (e.g., the second processor (233)) of a device (e.g., the optical wireless communication terminal (200)) may call at least one of the stored instructions from the storage medium and execute it. This enables the device to operate so as to perform at least one function in accordance with the called instruction(s). The one or more instructions may include code generated by a compiler or code that can be executed by an interpreter. The storage medium readable by the machine may be provided in the form of a non-transitory storage medium. Here, the term “non-transitory” merely means that the storage medium is a tangible device and does not include signals (e.g., electromagnetic waves), and the term does not distinguish between cases in which data are stored semi-permanently or temporarily in the storage medium.

According to an embodiment, a method according to various embodiments may be provided as a computer program product. The computer program product may be traded as a commercial item between a seller and a purchaser. The computer program product may be distributed in the form of a storage medium readable by a machine (e.g., a compact disc read-only memory (CD-ROM)), or may be distributed online (e.g., through downloading or uploading) via an application store (e.g., Play Store™) or directly between two user devices (e.g., smartphones). In the case of online distribution, at least a portion of the computer program product may be temporarily stored or generated in a storage medium readable by a machine, such as a memory of a manufacturer's server, an application store server, or an intermediate relay server.

The components according to various embodiments of the present disclosure may be implemented in the form of software or hardware such as a digital signal processor (DSP), a field programmable gate array (FPGA), or an application-specific integrated circuit (ASIC), and may perform specified functions. The term “components” is not limited to software or hardware, and each component may be configured to reside on an addressable storage medium and to be reproduced by one or more processors. By way of example, a component may include software components, object-oriented software components, class components, and task components, as well as processes, functions, attributes, procedures, subroutines, segments of program code, drivers, firmware, microcode, circuits, data, databases, data structures, tables, arrays, and variables.

According to various embodiments, each of the above described components (e.g., modules or programs) may include one or more entities. One or more of the foregoing components or operations may be omitted, or one or more other components or operations may be added. Alternatively or additionally, multiple components (e.g., modules or programs) may be integrated into a single component. In such a case, the integrated component may perform one or more functions of each of the multiple components in the same or similar manner as those performed by each component prior to the integration. According to various embodiments, operations performed by a module, program, or other component may be executed sequentially, in parallel, iteratively, or heuristically, and one or more of the operations may be executed in a different order, omitted, or one or more other operations may be added.

What is claimed is:

1. An optical wireless communication terminal, comprising:
an optical wireless transceiver including a transmitter, a receiver, and a communication controller; and
an integrated controller configured to monitor an output signal or operation information of the optical wireless transceiver,
wherein, while the optical wireless transceiver transmits or receives optical wireless data to or from a first optical wireless communication terminal, the integrated controller is configured to monitor whether an abnormality in a communication link or a relay operation condition occurs, based on at least one criterion among:
a received signal strength at the receiver, and
a change in a transmission directional angle associated with the transmitter,
and wherein, when the integrated controller detects the abnormality in the communication link or the relay operation condition,
the integrated controller is further configured to perform a reboot operation of the optical wireless transceiver, re-establish a communication link with the first optical wireless communication terminal after the reboot operation, and retransmit or receive again, by using the optical wireless transceiver, the optical wireless data whose transmission or reception is interrupted.

2. The optical wireless communication terminal of claim 1,
wherein the integrated controller is configured to detect the abnormality of the communication link when at least one of cases:
the signal strength is below a reference level, or
a change in the transmission directional angle is equal to or greater than a first threshold.

3. The optical wireless communication terminal of claim 2,
wherein, upon determining whether the signal strength is below the reference level,
the integrated controller is configured to check whether an elapsed time during which the signal strength remains below the reference level is equal to or greater than a reference time, and to detect the abnormality of the communication link when the elapsed time is equal to or greater than the reference time.

4. The optical wireless communication terminal of claim 2,
wherein the optical wireless transceiver further comprises a reset integrated circuit (reset IC) configured to activate a rebooting operation of the communication controller, and
wherein the integrated controller is configured to apply a reset signal to the reset IC when the at least one cases is satisfied, thereby performing the rebooting operation of the optical wireless transceiver.

5. The optical wireless communication terminal of claim 4, further comprising:
an output device configured to indicate an abnormality of the communication link or the relay operation condition,
wherein the integrated controller is configured to detect a reset signal applied in response to a user operation performed after confirming the indication through the output device, and to cause the reset IC to perform the rebooting operation.

6. The optical wireless communication terminal of claim 1, wherein re-establishing the communication link comprises:
performing an optical alignment with the first optical wireless communication terminal again after rebooting the optical wireless transceiver by using the optical wireless transceiver.

7. The optical wireless communication terminal of claim 1,
wherein rebooting the optical wireless transceiver comprises performing at least one operation among:
resetting and restarting the communication controller; powering off and then supplying power again; restarting an operating system; and
executing a flush of a memory or buffer to clear the optical wireless data.

8. The optical wireless communication terminal of claim 1, further comprising:
a directional angle controller configured to control a wide directional angle of the optical wireless transceiver,
wherein the integrated controller is configured to:
determine whether the change in the wide range directional angle is equal to or greater than a second threshold; and
upon such determination,
reboot the optical wireless transceiver,
adjust the wide directional angle of the directional angle controller,
subsequently adjust a precise directional angle of the transmitter,
perform an optical alignment with the first optical wireless communication terminal again, and
retransmit or receive again the optical wireless data.

9. The optical wireless communication terminal of claim 8, further comprising a mobile platform on which the optical wireless transceiver and the directional angle controller are mounted,
wherein the integrated controller is configured to:
detect an angular change of the platform by using a sensor provided in the platform;
reboot the optical wireless transceiver when the detected angular change is equal to or greater than a third threshold;
adjust the wide directional angle of the directional angle controller to correspond to the angular change of the platform;
subsequently adjust a precise directional angle of the optical wireless transceiver to perform an optical alignment with the first optical wireless communication terminal again; and
retransmit or receive again the optical wireless data.

10. The optical wireless communication terminal of claim 8,
wherein the second threshold is set to a value equal to or less than a product of a tangent value of a change in the precise directional angle and a communication distance to the first optical wireless communication terminal.

11. The optical wireless communication terminal of claim 1,
wherein the integrated controller is configured to act as a relay by:
receiving optical wireless data from a second optical wireless communication terminal through the optical wireless transceiver and storing the received optical wireless data in a memory;
disconnecting a communication link with the second optical wireless communication terminal after completing the receiving and storing of the optical wireless data; and
transmitting the stored optical wireless data to the first optical wireless communication terminal after performing an optical alignment with the first optical wireless communication terminal again.

12. A method for resolving a communication link failure by an integrated controller of a first optical wireless communication terminal, the first optical wireless communication terminal comprising: an optical wireless transceiver; and an integrated controller configured to monitor an output signal or operation information of the optical wireless transceiver, the method comprising:
monitoring at least one criterion among a received signal strength from a second optical wireless communication terminal and a change in a transmission directional angle toward the second optical wireless communication terminal;
verifying, based on the at least one criterion, whether an abnormality in a communication link or a relay operation condition occurs;
performing, when the abnormality in the communication link or the relay operation condition is detected, a rebooting operation of the optical wireless transceiver and re-establishing a communication link with the second optical wireless communication terminal; and
retransmitting, using the optical wireless transceiver, optical wireless data whose transmission is interrupted to the second optical wireless communication terminal.

13. The method of claim 12, wherein the verifying comprises:
determining that the communication link abnormality or the relay operation condition is present when at least one of:
the signal strength is below a reference level, or
a change in the transmission directional angle is equal to or greater than a first threshold.

14. The method of claim 13, wherein the verifying further comprises:
when the signal strength is below the reference level, checking whether a duration during which the signal strength remains below the reference level is equal to or greater than a reference time; and
determining that the abnormality in the communication link or the relay operation condition occurs when the duration is equal to or greater than the reference time.

15. The method of claim 12, wherein the rebooting operation comprises performing at least one operation among:
resetting and restarting the optical wireless transceiver;
powering off and re-supplying power;
restarting an operating system; and
executing a flush of a memory/buffer to clear optical wireless data.

16. The method of claim 12, wherein the transmission directional angle comprises a precise directional angle and a wide directional angle of the first optical wireless communication terminal.

17. The method of claim 16, wherein the verifying comprises:
determining whether a change in the precise directional angle is equal to or greater than a first threshold obtained as a product of a tangent of the precise directional angle change and a distance to the second optical wireless communication terminal; and
determining that an abnormality of the communication link or a relay operation condition occurs when the change in the precise directional angle is equal to or greater than the first threshold.

18. The method of claim 12, wherein the first optical wireless communication terminal further comprises a mobile platform on which the optical wireless transceiver is mounted, and the verifying comprise:
monitoring an angular change of the platform using a sensor provided in the platform and verifying whether the angular change is equal to or greater than a third threshold; and
determining that an abnormality of the communication link or a relay operation condition occurs when the angular change is equal to or greater than the third threshold.

19. The method of claim 12, comprising:
receiving the optical wireless data from second optical wireless communication terminal through the optical wireless transceiver and storing the data in a memory;
disconnecting a communication link with a third other optical wireless communication terminal when the receiving and storing of the optical wireless data are completed; and
performing a relay operation of transmitting the stored optical wireless data to the second optical wireless communication terminal.

20. A method for resolving a communication link failure by a first optical wireless communication terminal, the method comprising:
monitoring a change in at least one of a receiving directional angle and a transmitting directional angle;
detecting a relay operation or an abnormality in a communication link when the change in the directional angle with respect to a second optical wireless communication terminal exceeds a specified threshold;
performing at least one operation among clearing optical wireless data being transmitted stored in a memory and performing a rebooting operation, when the relay operation or the abnormality in the communication link is detected;
re-establishing a communication link with the second optical wireless communication terminal after performing the at least one operation; and
retransmitting or receiving again, through the re-established communication link, the optical wireless data being transmitted.
